(19) United States
(12) Patent Application Publication
(10) Pub. No.: US 2025/0243336 A1
(43) Pub. Date: Jul. 31, 2025

(54) MATERIAL FOR ENSURING THE FLOATABILITY AND/OR THE THERMAL INSULATION OF A SUBMARINE PIPELINE

(71) Applicant: SAIPEM S.A., Montigny le Bretonneux (FR)

(72) Inventors: Thierry DELAHAYE, Vanves (FR); Valérie OZOUX, Nevers (FR); Olivier LE-GUENNEC, Auffargis (FR); Nicolas SINGLING, Vincennes (FR)

(21) Appl. No.: 18/699,693

(22) PCT Filed: Sep. 28, 2022
(86) PCT No.: PCT/FR2022/051831

§ 371 Date: Apr. 9, 2024

(30) Foreign Application Priority Data
Oct. 14, 2021 (FR) 2110923

(51) Int. Cl. C08J 9/236; C08J 9/00; C08J 9/224; F16L 1/24; F16L 59/02

(52) U.S. Cl. CPC C08J 9/236; C08J 9/0061; C08J 9/224; F16L 1/24; F16L 59/028; C08J 2203/22; C08J 2205/044; C08J 2323/12; C08J 2345/00; C08J 2363/00; C08J 2375/04; C08J 2427/08; C08J 2433/20

(57) ABSTRACT

A material includes from 40 to 60% by volume of polymer matrix relative to the total volume of the material, and from 40 to 60% by volume, relative to the total volume of the material, of expanded thermoplastic microspheres. The membrane is composed of block polymers or copolymers. The microspheres are coated with a layer composed of nanoparticles of silicon dioxide and/or of titanium dioxide. A method for manufacturing is provided for making the material and the use of this material is provided for ensuring the floatability and/or for thermally insulating all or part of a submarine pipeline.

### TECHNICAL FIELD

The present invention relates to a material for ensuring the floatability of a submarine pipeline and/or for improving the thermal insulation of a submarine pipeline, in particular submarine pipelines intended for great depths and conveying hot or cold fluids. The present invention relates in particular to the field of upstream oil.

The present invention applies in particular to submarine pipelines installed on oil fields at great to very great depths, which can reach 2000 to 3000 m depth or even more and in which hydrocarbon fluids circulate.

### PRIOR ART

Crude oil comes out of the wellheads at temperatures of 45 to 75° C. or more, and at a water depth of 2000 to 3000 meters the water temperature is approximately 3-5° C. It is necessary to maintain the crude oil at a temperature above 20° C. until it reaches the surface to avoid gas hydrate plugs or above 40° C. to avoid the formation of paraffin plugs which would block production. Therefore, this requires efficient and continuous thermal insulation of the bottom-surface connection pipeline conveying the crude oil.

For this purpose, isolated pipelines of the “pipeline in a pipeline” type have been proposed in which an internal pipeline conveys the hydrocarbon fluid and an external pipeline coaxial with the previous one, also called “external envelope” is in contact with the ambient. The annular space between the two pipelines can be filled with an insulating material or else emptied of all gas.

Systems have been developed to respond in a more suitable way to the deep sea, that is to say to withstand the pressure of the seabed. In fact, the water pressure to which the pipeline must withstand can go up to at 30 M Pa, or around 300 bars for 3000 m or even 40 M Pa, or around 400 bars for 4000 m. Reference may in particular be made to coatings based on nearly incompressible polymer materials, for example based on polyurethane or polyethylene. However, these materials have insufficient thermal conductivity and thermal insulation properties to avoid the disadvantages of formation of plugs mentioned above in the event of a production stoppage for submarine pipelines conveying hydrocarbons.

There are also rigid insulating materials which also have interesting floatability, made up of synthetic materials including hollow microspheres (with a diameter of less than 0.1 mm) or macrospheres (with a diameter of 1 to 10 mm) containing a gas embedded in binders such as an epoxy or polyurethane resin, known to the person skilled in the art under the name of syntactic foam. However, these materials have poor resistance to pressure over time, particularly in a humid environment in the presence of a high temperature, and their manufacture is expensive. These syntactic foam insulating materials are used mainly for the insulation of submarine pipelines at great depths. Reference may in particular be made to syntactic foam type materials comprising glass microbeads dispersed in a homogeneous polymer matrix. However, the Applicant noticed that the microbeads tended to let water pass through and did not withstand hydrostatic pressure over time. The water intake of the glass beads can be attributed to 1) a hydration phenomenon which causes the water molecules to enter the glass by diffusion, to 2) an inter-diffusion phenomenon which causes the alkaline cations, such as potassium ions and sodium ions, to be dissolved in water and replaced by mobile hydrogen ions and which leads to the formation of silica nanocavities inside which water can circulate more easily, and/or 3) a hydrolysis phenomenon whereby the silica reacts with water to form silica hydroxides soluble in water.

This results in a progressive formation on the surface of the glass of a porous alteration layer with a thickness which can reach several microns. This phenomenon is intrinsically related to the chemical nature of glass. It is not a problem in most cases of glass use. On the other hand, for syntactic foams intended to be used in deep water, this is problematic because the thickness of the wall of the glass microbeads is of the same order of magnitude as the alteration layer. As a result, over time, the glass microbeads in contact with water become porous and gradually fill with water, causing the syntactic foams comprising same to lose their floatability and thermal insulation properties. This diffusion-driven phenomenon is particularly rapid when the temperature is high, particularly in pipelines containing hot oil or gas from wells. Moreover, the process for manufacturing glass microspheres is a very energy-intensive process and has a very low yield due to the different screening steps necessary to guarantee a level of dimensional homogeneity allowing to achieve the very strict technical specifications in force in the upstream oil sector.

There is therefore a need to offer an alternative to syntactic foams comprising glass microbeads, intended for use in a humid environment at great depth. It is interesting to note here that the problem of hydrolytic degradation of glass microbeads present in syntactic foams is not to date perfectly known in the field of syntactic foams. Thus, the Applicant addresses for the first time a little-known technical problem in the field of upstream oil and in particular syntactic foams used in this field.

Among the possible alternatives, reference can be made to microbeads covered with other ceramic materials instead of glass, obtained from polystyrene microbeads as a solid support. However, the use of polystyrene microbeads as a solid support has several difficulties, in particular it is not easy to have polystyrene microbeads of controlled size and surface properties at a reasonable cost for industrial use. There are polystyrene microbeads available by the ton at a low cost, manufactured in particular in China. However, the size distribution, agglomeration and surface properties of these microbeads do not allow obtaining hollow microbeads suitable for use on an industrial scale in syntactic foams for the thermal insulation and/or floatability of a submarine pipeline. In addition, the use of polystyrene microbeads as a solid support for the preparation of microbeads covered with other ceramic materials instead of glass requires carrying out a pyrolysis step at 300° C., which has a non-negligible energy cost, and leads to gas releases which break or pierce the balls during the sintering of these ceramics to obtain an impervious envelope.

One of the purposes of the present invention is to provide a new material having high floatability properties. Another purpose of the present invention is to provide a new material having high thermal insulation properties and resistance to hydrolytic degradation. Finally, the present invention also has the purpose of proposing a new material having said properties and the manufacture of which is easy, inexpensive and energy-saving compared to existing materials.

For this purpose, the present invention proposes a material comprising a polymer matrix in which expanded thermoplastic microspheres are dispersed, the membrane of which is composed of block polymers or copolymers, said microspheres being coated with a layer of nanoparticles of silicon dioxide and/or of titanium dioxide. The present invention also proposes a method for manufacturing this material and also the use of this material for ensuring the floatability and/or for thermally insulating all or part of a submarine pipeline.

### SUMMARY OF THE INVENTION

A first object of the invention relates to a material for ensuring the floatability of a submarine pipeline and/or for improving the thermal insulation of a submarine pipeline comprising:
from 40 to 60% by volume of polymer matrix relative to the total volume of the material, and
from 40 to 60% by volume, relative to the total volume of the material, of expanded thermoplastic microspheres, the membrane of which is composed of block polymers or copolymers, said microspheres being coated with a layer composed of nanoparticles of silicon dioxide and/or of titanium dioxide.

A second object of the invention relates to a method for manufacturing a material according to the invention in which the following successive steps are carried out: a) a step of preparing a solution comprising from 53 to 64% by weight relative to the total weight of the solution of tetraethyl orthosilicate in ethanol b) a step of preparing a solution comprising from 1.7 to 2% pure ammonia and 3 to 4% water in ethanol, the percentages being expressed by weight relative to the total weight of the solution, c) a step of progressively mixing 0.25 to 0.31% by weight relative to the total weight of the mixture of expanded thermoplastic microspheres, the membrane of which is composed of block polymers or copolymers with the solution prepared in step b), d) a step in which the mixture formed in step c) is allowed to settle, e) a step of recovering the supernatant, f) a step of washing with ethanol and vacuum filtrating the supernatant g) a step of drying at a temperature comprised between 5° and 70° C. for a period ranging from 12 h to 24 h, h) a step of mixing 40 to 60% by volume of microspheres obtained by steps a) to g) with 40 to 60% by volume of a polymer matrix, relative to the total volume of the material.

A third object of the invention relates to a method for manufacturing a material according to the invention in which the following successive steps are carried out: a) a step of preparing a solution comprising from 2.6 to 3.2% by weight relative to the total weight of the solution of silicon dioxide dissolved in a solution comprising from 3.6 to 4.4% sodium hydroxide in distilled water and having a pH comprised between 11 and 13 followed by the incorporation of 0.44 to 0.54% of expanded thermoplastic microspheres, the membrane of which is composed of block polymers or copolymers, b) a step of preparing a solution comprising from 5.3 to 6.5% of pure hydrochloric acid in distilled water, the percentages being expressed by weight relative to the total weight of the solution, c) a step of progressively mixing the solution prepared in step b) with the solution prepared in step a), d) a step in which the mixture formed in step c) is allowed to settle, e) a step of recovering the supernatant, f) a step of washing with ethanol and vacuum filtrating the supernatant, g) a step of drying at a temperature comprised between 5° and 70° C. for a period ranging from 12 h to 24 h, h) a step of mixing 40 to 60% by volume of microspheres obtained by steps a) to g) with 40 to 60% by volume of a polymer matrix, relative to the total volume of the material.

A fourth object of the invention relates to a method for manufacturing a material according to the invention in which the following successive steps are carried out: a) a step of preparing a solution comprising from 5.2 to 6.3% by weight relative to the total weight of the solution of titanium oxysulfate in distilled water followed by the incorporation of 0.39 to 0.47% of expanded thermoplastic microspheres, the membrane of which is composed of block polymers or copolymers b) a step of thermohydrolysis of titanium dioxide at a temperature comprised between 70 and 90° C. for 1 to 4 h c) a step in which the mixture formed in step b) is allowed to settle, d) a step of recovering the supernatant, e) a step of washing with ethanol and vacuum filtrating the supernatant f) a step of drying at a temperature comprised between 5° and 70° C. for a period ranging from 12 h to 24 h, g) a step of mixing 40 to 60% by volume of microspheres obtained by steps a) to f) with 40 to 60% by volume of a polymer matrix, relative to the total volume of the material.

A fifth object of the invention relates to a method for manufacturing a material according to the invention in which the following successive steps are carried out: a) preparing titanium dioxide microbeads according to steps a) to f) of the method according to the fourth object of the invention b) a step of preparing a solution comprising from 57 to 70% by weight relative to the total weight of the solution of tetraethyl orthosilicate in ethanol c) a step of preparing a solution comprising from 1.9 to 2.3% pure ammonia and 3.3 to 4.0% water in ethanol followed by the incorporation of 0.61 to 0.75% of titanium dioxide microbeads obtained in step a) the percentages being expressed by weight relative to the total weight of the solution, d) a step of progressively mixing the solution prepared in step b) in the solution prepared in step c), e) a step in which the mixture formed in step d) is allowed to settle, f) a step of recovering the supernatant, g) a step of washing with ethanol and vacuum filtrating the supernatant h) a step of drying at a temperature comprised between 50 and 70° C. for a period ranging from 12 h to 24 h, i) a step of mixing 40 to 60% by volume of microspheres obtained by steps a) to h) with 40 to 60% by volume of a polymer matrix, relative to the total volume of the material.

A sixth object of the invention relates to the use of a material according to the invention for ensuring the floatability of all or part of a submarine pipeline.

A seventh object of the invention relates to the use of a material according to the invention for thermally insulating all or part of a submarine pipeline.

### BRIEF DESCRIPTION OF THE FIGURES

FIG. 1 shows the image of a section by cryofracture of a material according to the invention after being subjected to a hydrostatic pressure of 200 bars for 1 hour, observed by scanning electron microscopy.

FIG. 2 shows the layer of nanoparticles of silicon dioxide with a thickness of 0.5 μm present on the surface of a thermoplastic microsphere implemented in a material according to the invention, observed by scanning electron microscope.

### DETAILED DESCRIPTION

The present invention relates to a material comprising a polymer matrix in which expanded thermoplastic microspheres are dispersed, the membrane of which is composed of block polymers or copolymers, said microspheres being coated with a layer of nanoparticles of silicon dioxide and/or of titanium dioxide. The present invention also proposes a method for manufacturing this material and also the use of this material for thermally insulating and/or for ensuring the floatability of all or part of a submarine pipeline.

Indeed, surprisingly the Applicant has developed a syntactic foam type material in which the glass microbeads generally used in the foams of the prior art are replaced by expanded thermoplastic microspheres coated with nanoparticles of silicon dioxide and/or of titanium dioxide.

Advantageously, the material according to the invention has positive floatability. According to another advantageous aspect, the material according to the invention has low thermal conductivity. The material according to the invention is therefore particularly useful for ensuring floatability and/or ensuring thermal insulation of all or part of a submarine pipeline.

The material according to the invention also has a low density. In addition, the material according to the invention has good resistance to hydrostatic pressure, for example up to 600 bars for use up to 4000 meters deep. The material according to the invention also has good resistance to hydrolytic degradation, good mechanical resistance over time, and a low production cost.

In addition, the process of manufacturing nanoparticles of silicon dioxide and/or of titanium dioxide is a soft chemical manufacturing process, having a high yield, allowing to achieve a very high degree of dimensional homogeneity without a subsequent screening step and without energy-intensive process of recasting or sintering a ceramic matrix. Moreover, all the raw materials are common chemical products produced in very large tonnage and at low cost. Finally, the synthesis process is relatively simple and lends itself readily to production on an industrial scale.

It was not easy to propose a material comprising microspheres coated with nanoparticles of silicon dioxide and/or of titanium dioxide, said microspheres being expanded thermoplastic microspheres, the membrane of which is composed of block polymers or copolymers. Indeed, it was not easy to identify a solid support and a substrate having good adhesion and being able to be dispersed homogeneously within the polymer matrix.

In addition, the material according to the invention is easy to manufacture but also to implement, for example by casting in a mold to form molded parts in a pre-constituted protective envelope, suitable for being disposed around a submarine pipeline.

The material according to the invention is also impervious to liquids and in particular to water. Preferably the material according to the invention has a water intake during use of up to 25 years, less than or equal to 5% by weight relative to the total weight of the material, preferably less than or equal to 1% by weight.

Thus, a first object of the invention relates to a material for ensuring the floatability of a submarine pipeline and/or for improving the thermal insulation of a submarine pipeline comprising:
from 40 to 60% by volume of polymer matrix relative to the total volume of the material, and
from 40 to 60% by volume, relative to the total volume of the material, of expanded thermoplastic microspheres, the membrane of which is composed of block polymers or copolymers, said microspheres being coated with a layer composed of nanoparticles of silicon dioxide and/or of titanium dioxide.

According to a particularly preferred embodiment, the material according to the invention comprises:
from 40 to 60% by volume of polymer matrix relative to the total volume of the material, and
from 40 to 60% by volume, relative to the total volume of the material, of expanded thermoplastic microspheres, the membrane of which is composed of block polymers or copolymers, said microspheres being coated with a layer composed of nanoparticles of silicon dioxide.

In the context of the invention, the expanded thermoplastic microspheres are obtained from thermoplastic microspheres, the membrane of which is composed of thermoplastic block polymers or copolymers such as vinyl chloride, vinylidene chloride, acrylonitrile, methacrylate and/or styrene, and containing one or more volatile liquid blowing agents which vaporize upon heating. The blowing agent may be a gas such as a hydrochlorofluorocarbon or chlorofluorocarbon gas such as trichlorofluoromethane or a hydrocarbon gas such as n-pentane, isopentane, butane, isobutane. The person skilled in the art has no difficulty in determining the heating parameters allowing the expansion of the microspheres as a function of the composition of the membrane of the microspheres and the blowing agent present. In the material according to the invention, the expanded thermoplastic microspheres are hollow.

According to a particular aspect of the material according to the invention, the membrane of the thermoplastic microspheres is composed of block polymers or copolymers of vinyl chloride, vinylidene chloride, acrylonitrile, methacrylate and/or styrene, preferably of a vinylidene chloride and acrylonitrile copolymer. Particularly preferably, the thermoplastic microspheres are hydrated on the surface, preferably up to 30% by weight relative to the total weight of the microspheres.

According to a preferred embodiment of the material according to the invention, the membrane of the expanded thermoplastic microspheres is composed of a vinylidene chloride and acrylonitrile block copolymer. Preferably according to this embodiment, the membrane of the expanded thermoplastic microspheres comprises from 10% to 60% of vinylidene chloride, and from 20% to 90% of acrylonitrile, by weight relative to the weight of the membrane.

In particular in the context of the invention, the expanded thermoplastic microspheres have a density comprised between 20 and 40 kg/m³ and a diameter comprised between 10 and 50 μm, preferably between 20 and 40 μm. The small size of the microspheres facilitates their dispersion within the matrix. According to a particularly preferred aspect, the microspheres used in the material according to the invention have a diameter of 20 μm or 40 μm and a density of 36 kg/m³, more preferably the microspheres have a diameter of 40 μm and a density of 36 kg/m³. Such microspheres are available from the company Nouryon under the trade name Expancel®.

According to a particularly preferred embodiment, the microspheres used in the context of the invention have a membrane composed of a vinylidene chloride and acrylonitrile block copolymer, said microspheres being hydrated on the surface up to 30% by weight of water relative to the total weight of the microspheres and having a diameter of 20 or 40 μm and a density of 36 kg/m³.

According to a particular aspect, the expanded thermoplastic microspheres used in the material according to the invention have a thickness ranging from 0.1 μm to 1 μm, preferably from 0.2 μm to 0.7 μm, more preferably ranging from 0.2 μm to 0.5 μm.

It is understood that in the material according to the invention the expanded thermoplastic microspheres coated with a layer composed of nanoparticles of silicon dioxide and/or of titanium dioxide are dispersed in the polymer matrix and that the polymer matrix fills all the interstices between said microspheres.

The expanded thermoplastic microspheres coated with a layer of nanoparticles of silicon dioxide and/or of titanium dioxide present in the material according to the invention, have a size homogeneity, a density homogeneity and a layer of nanoparticles of silicon dioxide and/or of titanium dioxide which is homogeneous and of regular thickness.

The size homogeneity can be determined by measuring dynamic light scattering, the density can be measured by measuring the density, the homogeneity and/or regularity of the nanoparticle layer can be determined by scanning electron microscopy.

In the context of the present invention, nanoparticles of silicon dioxide mean nanoparticles with the chemical formula “SiO₂”. In the context of the present invention, titanium dioxide nanoparticles mean nanoparticles with the chemical formula “TiO₂”.

The nanoparticles of silicon dioxide used in the material according to the invention can be synthesized using any method known from the prior art and allowing to obtain monocrystalline and monodisperse nanoparticles of silicon dioxide. Reference can in particular be made to the sol-gel synthesis method by the Stöber reaction involving tetraethyl orthosilicate molecules in the presence of ethanol (described in the publication Stöber, Fink, & Bohn, 1968, Controlled Growth of Monodisperse Silica Spheres in the Micron Size Range. JOURNAL OF COLLOID AND INTERFACE SCIENCE, 26, 62-69). This method advantageously allows to obtain monocrystalline, monodisperse nanoparticles of silicon dioxide in a perfectly controlled manner, at low cost and easily. Reference can also be made to the synthesis method called silicate synthesis method using acid precipitation of silicon dioxide previously dissolved in sodium hydroxide.

The titanium dioxide nanoparticles used in the material according to the invention can be synthesized using any method known from the prior art and allowing to obtain monocrystalline and monodisperse titanium dioxide nanoparticles. Reference can in particular be made to the synthesis method using the thermohydrolysis of titanium oxysulfate (described in the publication of Rn and al. in 2012, Controllable Synthesis of Mesostructures from TiO2 Hollow to Porous Nanospheres with Superior Rate Performance for Lithium Ion Batteries. Chemical Science, 00, 1-3).

In particular and advantageously, the layer composed of nanoparticles of silicon dioxide and/or of titanium dioxide with which the microspheres are coated, is a layer impervious to liquids and in particular to water, in particular said membrane is neither microporous nor mesoporous. The imperviousness of the layer of nanoparticles of silicon dioxide and/or of titanium dioxide allows to preserve the mechanical properties of the microspheres and to limit their degradation related to contact with water during their duration of use.

In the context of the present invention, the layer of nanoparticles of silicon dioxide and/or of titanium dioxide is homogeneous and of regular thickness, said parameters being able for example to be determined by scanning electron microscopy.

In particular, the layer composed of nanoparticles of silicon dioxide and/or of titanium dioxide has a thickness ranging from 0.5 to 1 μm.

In particular, the polymer matrix present in the material according to the invention is selected from an epoxy matrix, a polyurethane matrix, a polypropylene matrix or a poly-dicyclopentadiene matrix. According to a preferred embodiment, the polymer matrix is a polyurethane matrix for use, in particular underwater, at a temperature less than or equal to 60° C. According to another preferred embodiment, the polymer matrix is made of poly-dicyclopentadiene for use, in particular underwater, at high temperatures, in particular at temperatures beyond 60° C.

According to a particular aspect, the material according to the invention has a density ranging from 0.4 to 0.8 T/m³, preferably ranging from 0.5 to 0.7 T/m³, a thermal conductivity measured with a thermal mass flow meter ranging from 0.06 to 0.13 W/mK, preferably ranging from 0.06 to 0.12 W/mK. More particularly, the material according to the invention has a resistance to hydrostatic pressure greater than 200 bars.

The density of the material according to the invention can be measured by any method known to the person skilled in the art, for example by measuring the buoyant force.

The thermal conductivity of the material according to the invention can be measured by any method known to the person skilled in the art, for example with a thermal mass flow meter.

The pressure at the hydrostatic resistance can be measured by any method known to the person skilled in the art, for example by visually observing that the volume and mass of the material are unchanged and/or by observing a section of said material by scanning electron microscopy that the microspheres present in the material according to the invention are neither deformed nor broken.

The mechanical resistance of the material according to the invention can be measured by different methods such as a hydrostatic pressure resistance test (according to standard ASTM D 732 or annex A of standard ISO 12736:2014) or else mechanical tests of resistance to traction according to standard ISO 527 and to compression according to standard ISO 844. The resistance of the material according to the invention to hydrolytic degradation can for example be measured by aging tests according to standard ISO 12736.

In the context of the invention, “thermal insulator” means a material whose thermal conductivity properties are less than 0.25 W/mK, preferably less than 0.20 W/mK and even more preferably less than 0.15 W/mK. In the context of the present invention, “positive floatability” means a material whose density is less than 1 T/m³.

The material according to the invention has mechanical properties compatible with use in an underwater environment at great depths of water, in particular said material has resistance to a hydrostatic pressure equal to or greater than 200 bars, which is equivalent to 2000 meters depth. The material according to the invention is also suitable for being installed in an underwater environment at great depth via a “J” or S″ installation through a tensioner.

Another object of the present invention relates to a method for manufacturing the material according to the first object of the invention.

In particular, the present invention relates to a method for manufacturing a material according to the invention in which the following successive steps are carried out: a) a step of preparing a solution comprising from 53 to 64% by weight relative to the total weight of the solution of tetraethyl orthosilicate in ethanol b) a step of preparing a solution comprising from 1.7 to 2% pure ammonia and 3 to 4% water in ethanol, the percentages being expressed by weight relative to the total weight of the solution, c) a step of progressively mixing 0.25 to 0.31% by weight relative to the total weight of the mixture of expanded thermoplastic microspheres, the membrane of which is composed of block polymers or copolymers with the solution prepared in step b), d) a step in which the mixture formed in step c) is allowed to settle, c) a step of recovering the supernatant, f) a step of washing with ethanol and vacuum filtrating the supernatant g) a step of drying at a temperature comprised between 5° and 70° C. for a period ranging from 12 h to 24 h, h) a step of mixing 40 to 60% by volume of microspheres obtained by steps a) to g) with 40 to 60% by volume of a polymer matrix, relative to the total volume of the material.

Another object of the invention relates to a method for manufacturing a material according to the invention in which the following successive steps are carried out: a) a step of preparing a solution comprising from 2.6 to 3.2% by weight relative to the total weight of the solution of silicon dioxide dissolved in a solution comprising from 3.6 to 4.4% sodium hydroxide in distilled water and having a pH comprised between 11 and 13 followed by the incorporation of 0.44 to 0.54% of expanded thermoplastic microspheres, the membrane of which is composed of block polymers or copolymers b) a step of preparing a solution comprising from 5.3 to 6.5% of pure hydrochloric acid in distilled water, the percentages being expressed by weight relative to the total weight of the solution, c) a step of progressively mixing the solution prepared in step b) with the solution prepared in step a), d) a step in which the mixture formed in step c) is allowed to settle, e) a step of recovering the supernatant, f) a step of washing with ethanol and vacuum filtrating the supernatant g) a step of drying at a temperature comprised between 5° and 70° C. for a period ranging from 12 h to 24 h, h) a step of mixing 40 to 60% by volume of microspheres obtained by steps a) to g) with 40 to 60% by volume of a polymer matrix, relative to the total volume of the material.

Another object of the invention relates to a method for manufacturing a material according to the invention in which the following successive steps are carried out: a) a step of preparing a solution comprising from 5.2 to 6.3% by weight relative to the total weight of the solution of titanium oxysulfate in distilled water followed by the incorporation of 0.39 to 0.47% of expanded thermoplastic microspheres, the membrane of which is composed of block polymers or copolymers b) a step of thermohydrolysis of titanium dioxide at a temperature comprised between 7° and 90° C. for 1 to 4 h c) a step in which the mixture formed in step b) is allowed to settle, d) a step of recovering the supernatant, e) a step of washing with ethanol and vacuum filtrating the supernatant f) a step of drying at a temperature comprised between 50 and 70° C. for a period ranging from 12 h to 24 h, g) a step of mixing 40 to 60% by volume of microspheres obtained by steps a) to f) with 40 to 60% by volume of a polymer matrix, relative to the total volume of the material.

Another object of the invention relates to a method for manufacturing a material according to the invention in which the following successive steps are carried out: a) preparing titanium dioxide microbeads according to steps a) to f) of the method according to the fourth object of the invention b) a step of preparing a solution comprising from 57 to 70% by weight relative to the total weight of the solution of tetraethyl orthosilicate in ethanol c) a step of preparing a solution comprising from 1.9 to 2.3% pure ammonia and 3.3 to 4.0% water in ethanol followed by the incorporation of 0.61 to 0.75% of titanium dioxide microbeads obtained in step a) the percentages being expressed by weight relative to the total weight of the solution, d) a step of progressively mixing the solution prepared in step b) in the solution prepared in step c), c) a step in which the mixture formed in step d) is allowed to settle, f) a step of recovering the supernatant, g) a step of washing with ethanol and vacuum filtrating the supernatant h) a step of drying at a temperature comprised between 50 and 70° C. for a period ranging from 12 h to 24 h, i) a step of mixing 40 to 60% by volume of microspheres obtained by steps a) to h) with 40 to 60% by volume of a polymer matrix, relative to the total volume of the material.

In the methods according to the invention, the membrane of the thermoplastic microspheres is composed of block polymers or copolymers of vinyl chloride, vinylidene chloride, acrylonitrile, methacrylate and/or styrene, preferably a vinylidene chloride and acrylonitrile copolymer. Particularly preferably, the thermoplastic microspheres are hydrated on the surface, preferably up to 30% by weight relative to the total weight of the microspheres.

According to a preferred embodiment, the membrane of the expanded thermoplastic microspheres is composed of a vinylidene chloride and acrylonitrile block copolymer. Preferably according to this embodiment, the membrane of the expanded thermoplastic microspheres comprises from 10% to 60% of vinylidene chloride, and from 20% to 90% of acrylonitrile, by weight relative to the weight of the membrane.

The technical characteristics set out upstream in connection with the material according to the invention and the elements composing it, apply in the same way to the manufacturing methods according to the invention.

The mixing of expanded thermoplastic microspheres covered with a layer of nanoparticles of silicon dioxide and/or of titanium dioxide with the polymer matrix can be carried out within an extruder.

Another object of the present invention relates to the use of a material according to the first object for ensuring the floatability of all or part of a submarine pipeline.

Another object of the present invention relates to the use of a material according to the first object for thermally insulating all or part of a submarine pipeline.

Preferably the material according to the invention insulates or ensures the floatability of an entire submarine pipeline.

For each of the uses according to the invention, the material according to the first object of the invention can be placed around all or part of a submarine pipeline, upstream of the immersion of the submarine pipeline in the water or else later.

Advantageously, the material according to the invention is confined in a protective envelope. The outer envelope may be made of metal, such as stainless steel, aluminum and metal alloys, but may also be made of polymeric synthetic material, such as polypropylene, polyethylene, polyamides, polyurethanes or any other polymer convertible into tubes, into plates or into envelopes, or else obtained by rotational molding of thermoplastic powders, or else of composite materials.

The outer envelope may preferably be a thick, more or less rigid layer, from a few millimeters to several centimeters thick, but may also be in the form of a flexible or semi-rigid film.

The free space between the underwater fluid transport pipeline and the external envelope, where the material according to the invention will be applied, can be variable and will be defined according to the desired degree of insulation, calculated from the coefficient of insulation of the material according to the invention and the temperatures to be maintained, or the desired floatability calculated from the density of the material according to the invention.

More particularly, the material according to the invention is in the form of a pre-molded part, preferably capable of being applied around a submarine pipeline or a submarine pipeline element to ensure thermal insulation and/or or floatability thereof and resistant to underwater hydrostatic pressure, preferably at a water depth of at least 1000 m.

When the material according to the invention is in this pre-molded form it forms an annular buoy.

Thus, another object of the invention relates to a product, in particular a floatability buoy consisting of the material according to the invention. Preferably according to this object, the material according to the invention is pre-molded so that it can be applied around a submarine pipeline or a submarine pipeline element.

The material according to the invention can be used in the context of different uses not belonging to the field of upstream oil. For example, the material according to the invention can in fact be used to cushion a shock, for acoustic insulation or else as a shielding material.

### EXAMPLES

### Example 1: Study of the Technical Properties of a Material According to the Invention

### a) Material and Methods:

40 to 50% of expanded thermoplastic microspheres, the membrane of which is composed of a vinylidene chloride and acrylonitrile copolymer, are mixed in an internal mixer before being injected using an extruder with 50 to 60% of a polymer matrix, the percentages being expressed by weight relative to the total weight of the material. Different polymer matrices were tested including epoxy matrices, a polyurethane matrix, a polypropylene matrix or a poly-dicyclopentadiene matrix.

The density of the material according to the invention was measured by buoyant force, as described for example in standard ISO 1183.

The thermal conductivity of the material according to the invention was measured using a thermal mass flow meter, as described for example in standard ISO 8301.

The heat capacity of the material according to the invention was measured by differential scanning calorimetry, as described for example in standard ISO 11357-2.

The mechanical resistance at a hydrostatic pressure of 200 bars of the material according to the invention was observed by scanning electron microscopy of a section by cryofracture after immersion at 200 bars for 1 hour of the material according to the invention.

### b) Results

Regardless of the nature of the polymeric matrix used:

The material according to the invention has a density comprised between 0.5 and 0.7 T/m³.

The material according to the invention has a thermal conductivity comprised between 0.06 and 0.12 W/mK depending on the type of matrix used and the volume proportion of microspheres.

The material according to the invention has a heat capacity of the material comprised between 900 and 1900 J/kg·K depending on the type of matrix used and the volume proportion of microspheres.

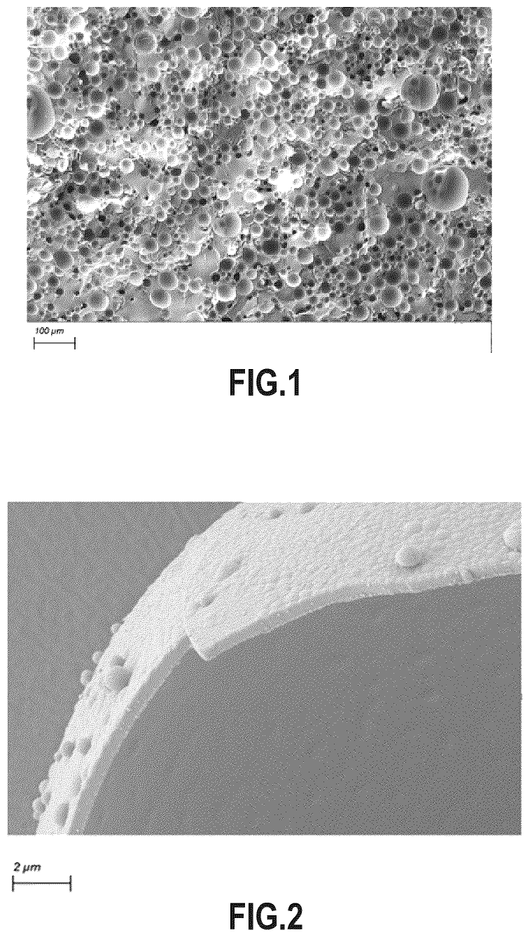

The material according to the invention withstands a hydrostatic pressure of at least 200 bars (FIG. 1). It is noted in fact that the volume and mass of the material have not changed and that the microspheres are intact.

1.-13. (canceled)

14. A material for ensuring the floatability of a submarine pipeline and/or for improving the thermal insulation of a submarine pipeline comprising:
from 40 to 60% by volume of polymer matrix relative to the total volume of the material, and
from 40 to 60% by volume, relative to the total volume of the material, of expanded thermoplastic microspheres, the membrane of which is composed of block polymers or copolymers, said microspheres being coated with a layer composed of nanoparticles of silicon dioxide and/or of titanium dioxide.

15. The material according to claim 14, wherein the membrane of the thermoplastic microspheres is composed of block polymers or copolymers of vinyl chloride, vinylidene chloride, acrylonitrile, methacrylate and/or styrene.

16. The material according to claim 14, wherein the microspheres have a density comprised between 20 and 40 kg/m3 and a diameter comprised between 10 and 50 μm.

17. The material according to claim 14, wherein the microspheres have a thickness ranging from 0.1 μm to 1 μm.

18. The material according to claim 14, wherein the layer composed of nanoparticles of silicon dioxide and/or of titanium dioxide has a thickness ranging from 0.5 to 1 μm.

19. The material according to claim 14, wherein the polymer matrix is selected from an epoxy matrix, a polyurethane matrix, a polypropylene matrix or a poly-dicyclopentadiene matrix.

20. The material according to claim 14, wherein it has a density ranging from 0.4 to 0.8 T/m3, a thermal conductivity measured with a thermal mass flow meter ranging from 0.06 to 0.13 W/mK.

21. A method for manufacturing a material according to claim 14, wherein the following successive steps are carried out:
a) a step of preparing a solution comprising from 53 to 64% by weight relative to the total weight of the solution of tetraethyl orthosilicate in ethanol,
b) a step of preparing a solution comprising from 1.7 to 2% pure ammonia and 3 to 4% water in ethanol, the percentages being expressed by weight relative to the total weight of the solution,
c) a step of progressively mixing 0.25 to 0.31% by weight relative to the total weight of the mixture of expanded thermoplastic microspheres, the membrane of which is composed of block polymers or copolymers with the solution prepared in step b),
d) a step in which the mixture formed in step c) is allowed to settle,
e) a step of recovering the supernatant,
f) a step of washing with ethanol and vacuum filtrating the supernatant
g) a step of drying at a temperature comprised between 50 and 70° C. for a period ranging from 12 h to 24 h,
h) a step of mixing 40 to 60% by volume of microspheres obtained by steps a) to g) with 40 to 60% by volume of a polymer matrix, relative to the total volume of the material.

22. The method for manufacturing a material according to claim 14, wherein the following successive steps are carried out:
a) a step of preparing a solution comprising from 2.6 to 3.2% by weight relative to the total weight of the solution of silicon dioxide dissolved in a solution comprising from 3.6 to 4.4% sodium hydroxide in distilled water and having a pH comprised between 11 and 13 followed by the incorporation of 0.44 to 0.54% of expanded thermoplastic microspheres, the membrane of which is composed of block polymers or copolymers
b) a step of preparing a solution comprising from 5.3 to 6.5% of pure hydrochloric acid in distilled water, the percentages being expressed by weight relative to the total weight of the solution,
c) a step of progressively mixing the solution prepared in step b) with the solution prepared in step a),
d) a step in which the mixture formed in step
c) is allowed to settle,
e) a step of recovering the supernatant,
f) a step of washing with ethanol and vacuum filtrating the supernatant
g) a step of drying at a temperature comprised between 50 and 70° C. for a period ranging from 12 h to 24 h,
h) a step of mixing 40 to 60% by volume of microspheres obtained by steps a) to g) with 40 to 60% by volume of a polymer matrix, relative to the total volume of the material.

23. The method for manufacturing a material according to claim 14, wherein the following successive steps are carried out:
a) a step of preparing a solution comprising from 5.2 to 6.3% by weight relative to the total weight of the solution of titanium oxysulfate in distilled water followed by the incorporation of 0.39 to 0.47% of expanded thermoplastic microspheres, the membrane of which is composed of block polymers or copolymers
b) a step of thermohydrolysis of titanium dioxide at a temperature comprised between 7° and 90° C. for 1 to 4 h
c) a step in which the mixture formed in step b) is allowed to settle,
d) a step of recovering the supernatant,
e) a step of washing with ethanol and vacuum filtrating the supernatant
f) a step of drying at a temperature comprised between 50 and 70° C. for a period ranging from 12 h to 24 h,
g) a step of mixing 40 to 60% by volume of microspheres obtained by steps a) to f) with 40 to 60% by volume of a polymer matrix, relative to the total volume of the material.

24. The method for manufacturing a material according to claim 14, wherein the following successive steps are carried out:
a) preparing titanium dioxide microbeads according to steps a) to f) of the method according to claim 10
b) a step of preparing a solution comprising from 57 to 70% by weight relative to the total weight of the solution of tetraethyl orthosilicate in ethanol
c) a step of preparing a solution comprising from 1.9 to 2.3% pure ammonia and 3.3 to 4.0% water in ethanol followed by the incorporation of 0.61 to 0.75% of titanium dioxide microbeads obtained in step a) the percentages being expressed by weight relative to the total weight of the solution,
d) a step of progressively mixing the solution prepared in step b) in the solution prepared in step c),
e) a step in which the mixture formed in step d) is allowed to settle,
f) a step of recovering the supernatant,
g) a step of washing with ethanol and vacuum filtrating the supernatant
h) a step of drying at a temperature comprised between 50 and 70° C. for a period ranging from 12 h to 24 h,
i) a step of mixing 40 to 60% by volume of microspheres obtained by steps a) to h) with 40 to 60% by volume of a polymer matrix, relative to the total volume of the material.

25. A use of a material according to claim 14, for ensuring the floatability of all or part of a submarine pipeline.

26. The use of a material according to claim 14, for thermally insulating all or part of a submarine pipeline.
